(19) United States
(12) Patent Application Publication
(10) Pub. No.: US 2024/0211914 A1
(43) Pub. Date: Jun. 27, 2024

(54) POINT OF SALE (POS) SYSTEM FOR IMPROVING A STORE OPERATION EFFICIENCY AND METHOD OF OPERATING POS SYSTEM

(71) Applicant: Tomorrow POS, Inc., Atlanta, GA (US)

(72) Inventors: Jee Sang Yun, Hanam-si (KR); YongSeung Kim, Hwaseong-si (KR)

(21) Appl. No.: 18/069,442

(22) Filed: Dec. 21, 2022

Related U.S. Application Data
(60) Provisional application No. 63/293,927, filed on Dec. 27, 2021.

(51) Int. Cl. G06Q 20/20; G06F 9/54

(52) U.S. Cl. CPC G06Q 20/202; G06F 9/54

(57) ABSTRACT

This application relates to a point of sale (POS) system for a dry-cleaning store, a tailor shop, laundry related business and a method of operating the POS system. The POS system includes a POS device, a network module, and an application programming interface (API) module. The API module receives data from a user. The POS device includes a database configured to store customer information and historical transaction data and a POS management processor in data communication with the database. The POS management processor optimizes the database by updating the customer information and historical transaction data, calculates service and product cost intelligently based on the customer information and historical data, and produces a consolidated summary of sales. The network module stores processed data as a back-up. The POS system can perform fast transaction turnaround, an optimized database, an advanced customer management function using cloud and mobile services.

### CROSS-REFERENCE TO RELATED APPLICATIONS

The present application claims priority to U.S. Provisional Patent Application No. 63/293,927, filed on Dec. 27, 2021, the entire disclosure of which is incorporated herein by reference.

### BACKGROUND

The described technology generally relates to point of sale (POS) system for a dry cleaning store, a tailor shop, or other laundry related businesses, and a method of operating the POS system.

### SUMMARY

The embodiments disclosed herein each have several aspects, no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing systems, devices, and methods for processing data in a POS system.

One aspect is a POS system for improving a store operation efficiency, comprising: a network module, a device, and an application programming interface (API) module.

In the above system, the network module comprises a backup server, a service server, and a developer terminal. In the above system, the device comprises a database, a POS management module, and a display unit.

In the above system, the API module comprises an application and an external API module interface. In the above system, the API module can be installed on a personal device. In the above system, the backup server, the POS management module, and the application are wirelessly connected.

Another aspect is a method of improving a store operation efficiency by using a POS system comprising: wirelessly connecting a device an API module, and a network module; receiving data from a user; sending the data to a POS management module in the device; processing the data; sending the processed data to an application in the API module; and storing the data in a backup server in the network module.

In the above method, a method of using the API module in the POS system comprising: receiving an input data from a user; sending the input data to a POS management module; setting the API module status as inactive; receiving data from the POS management module; changing the API module status as an active; sending a message to a user through an SMS API module, wherein the SMS API module is connected to the application through an external API module interface; sending a message to the user to make a payment and process the payment transaction, wherein the payment API module is connected to the application through an external API module interface; sending the processed data to a backup server; and updating the database.

In the above method, a method of using a device in the POS system comprising: receiving an input data from an application; scanning a database to find a user identification number; writing the input data under the user's identification number in the database; processing the input data; updating the database by uploading the processed data; sending the processed data to the application; receiving any user input regarding the processed data; updating a backup server; and updating the database.

In the above method, the method of receiving data input comprises one or more of: a customer identification number assigned to each customer; a user's request; and a service type.

In the above method, the scanning a customer database comprises one or more: a service electronic record database configured to store one or more of electronic records of service; an item label data database configured to store data for one or more of service labels; a customer data database configured to store data for one or more of customer's identification number; and a customer's electronic record database configured to store the service provided to the customer.

One aspect is a system for improving a store operation efficiency, comprising: a device connected to a network module; an application programming interface (API) module connected to the device wirelessly; a means for accessing a database, configured to be activated upon receiving a user's input; a means for processing, configured to be activated upon the API module sends a request; and a means for storing, configured to be activated upon completing the user's request.

In the above system, the device is wirelessly connected to the network module and the API module using one or more of the following protocols: Bluetooth protocol, local area network (LAN) protocol, mesh network module protocol, Internet protocol (IP), or mobile Internet protocol (MIP).

Another aspect is a system for improving a store operation efficiency using a point of sale (POS) platform for a dry cleaning store, a tailor shop, or other laundry related businesses, the system comprising: an application programming interface (API) module configured to receive data from a user; a POS device in wireless data communication with the API module and comprising: a database configured to store customer information and historical transaction data; and a POS management processor in data communication with the database and configured to: optimize the database by updating the customer information and historical transaction data, calculate service and product cost intelligently based on the customer information and historical data, and produce a consolidated summary of sales, and a network module in wireless data communication with the POS device and configured to store the updated customer information and the historical transaction data as a back-up.

In the above system, the network module comprises at least one of a cloud, a backup server, a service server, or a developer terminal. In the above system, the POS device further comprises a display unit configured to display the produced consolidated summary of sales. In the above system, the API module comprises an application configured to receive the data from the user and an external API module interface configured to communicate data with a third party payment server. In the above system, the API module is configured to be installed on a personal mobile device.

In the above system, the backup server, the POS management module, and the application are wirelessly connected. In the above system, the wireless connection uses one or more of the following protocols: Bluetooth protocol, local area network (LAN) protocol, mesh network module protocol, Internet protocol (IP), or mobile Internet protocol (MIP). In the above system, the database comprises a web-based cloud storage.

Another aspect is a method of improving store operation efficiency by using a point of sale (POS) platform for a dry cleaning store, a tailor shop, or other laundry related businesses, the method comprising: wirelessly connecting a POS device, an application programming interface (API) module, and a network module; receiving, at the API module, data from a user; sending, at the API module, the data to a POS management module of the POS device; storing, at a database of the POS device, customer information and historical transaction data; processing, at the POS management processor, the data, the processing comprising: optimizing the database by updating the customer information and historical transaction data, calculating service and product cost intelligently based on the customer information and historical data, and producing a consolidated summary of sales; sending the processed data to an application of the API module; and storing the processed data in a backup server of the network module.

The above method further comprises at the API module: setting an API module status as inactive after the data is sent to the POS management module; receiving data from the POS management module; changing the API module status as active; sending a message to the user through an short message service (SMS) API module, wherein the SMS API module is connected to an application of the API module through an external API module interface; and sending a message to the user to make a payment and process a payment transaction.

The above method further comprises at the POS device: receiving an input data from an application of the API module; scanning the database of the POS device to determine a user identification number; writing the input data under the user's identification number in the database; processing the input data; updating the database by uploading the processed data; sending the processed data to the application; receiving any user input regarding the processed data; updating the backup server of the network module; and updating the database. The above method further comprises: receiving an input data; storing the input data under the customer's identification number; receiving a completion status; sending a notification to the user; and processing payment transactions.

Another method is a point of sale (POS) device for a dry cleaning store, a tailor shop, or other laundry related businesses, the system comprising: a database configured to store customer information and historical transaction data; and a processor in data communication with the database and configured to: optimize the database by updating the customer information and historical transaction data; calculate service and product cost intelligently based on the customer information and historical data; and produce a consolidated summary of sales.

The above POS device further comprises a display configured to display the produced consolidated summary of sales. In the above POS device, the POS device is integrated into a self-ordering kiosk.

Another aspect is a method of operating a point of sale (POS) device for a dry cleaning store, a tailor shop, or other laundry related businesses, the method comprising: storing, at a database, customer information and historical transaction data; optimizing, at a processor of the POS device, the database by updating the customer information and historical transaction data; calculating, at the processor, service and product cost intelligently based on the customer information and historical data; and producing, at the processor, a consolidated summary of sales.

Another aspect is a point of sale (POS) device for a dry cleaning store, a tailor shop, or other laundry related businesses, the system comprising: means for storing customer information and historical transaction data; means for optimizing the storing means by updating the customer information and historical transaction data; means for calculating service and product cost intelligently based on the customer information and historical data; and means for producing a consolidated summary of sales.

In the above POS device, the storing means comprises a database. In the above POS device, the optimizing means, the calculating means, and the producing means comprise a POS management processor.

Another aspect is a non-transitory computer readable medium comprising instructions to perform a method of operating a point of sale (POS) device for a dry cleaning store, a tailor shop, or other laundry related businesses, the method comprising: storing, at a database, customer information and historical transaction data; optimizing, at a processor, the database by updating the customer information and historical transaction data; calculating, at the processor, service and product cost intelligently based on the customer information and historical data; and producing, at the processor, a consolidated summary of sales.

Another aspect is a server for communicating data with a point of sale (POS) device for a dry cleaning store, a tailor shop, or other laundry related businesses, the server comprising: a memory; and a controller in data communication with the memory and configured to: communicate data with the POS device; cause a database of the POS device to store customer information and historical transaction data; and cause a POS management processor of the POS device to: optimize the database by updating the customer information and historical transaction data; calculate service and product cost intelligently based on the customer information and historical data; and produce a consolidated summary of sales.

Another aspect is a mobile apparatus for communicating data with a point of sale (POS) device for a dry cleaning store, a tailor shop, or other laundry related businesses, the mobile apparatus comprising: a memory; and a controller in data communication with the memory and configured to: communicate data with the POS device; cause a database of the POS device to store customer information and historical transaction data; and cause a POS management processor of the POS device to: optimize the database by updating the customer information and historical transaction data; calculate service and product cost intelligently based on the customer information and historical data; and produce a consolidated summary of sales.

### BRIEF DESCRIPTION OF THE DRAWINGS

The foregoing and other features of the disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 shows a typical POS system used for a dry-cleaning store, a tailor shop, laundry related business.

FIG. 2 illustrates an example block diagram of a POS system for improving a store operation efficiency by using a POS device according to some embodiments.

FIGS. 3A-3D show various features of an application according to some embodiments.

FIG. 4 shows an example of a database management function according to some embodiments.

FIG. 5 shows an example block diagram of the device according to some embodiments.

FIG. 6. shows an example of POS system maintenance according to some embodiments.

FIGS. 7A-7C illustrate various embodiments of a remote connection between a web POS and a store according to some embodiments.

FIG. 8 is an example process flow diagram of a method for improving a store operation efficiency by using a POS system according to some embodiments.

FIG. 9 is another example process flow diagram of a method for improving a store operation efficiency by using a POS system according to some embodiments.

FIG. 10 is another example process flow diagram of a method for improving a store operation efficiency by using a POS system according to some embodiments.

FIG. 11 is another process flow diagram of a method for improving a store operation efficiency by using a POS system according to some embodiments.

FIG. 12 is one embodiment of the POS system to create a consolidated and improved summary of sale.

### DETAILED DESCRIPTION

Provided herein are various embodiments of systems and methods for improving a store operation efficiency using point of sale (POS). Embodiments described herein can significantly increase the store operation efficiency by wirelessly controlling the store operation using a portable device. For example, the POS system can perform fast transaction turnaround, generate an optimized database and provide an advanced customer management function using cloud and mobile devices, and also can support a man-less kiosk mode, and advanced user-friendly interfaces by categorization. Thus, various embodiments can reduce customer dissatisfaction and improve store operation efficiency.

The POS system or POS device in a store such as a laundry store provides a platform for a business transaction. Using the POS system in the laundry industry, a customer can execute any transaction without an in-person meeting. For example, a customer can select any services provided in the laundry store by selecting the services shown in a display unit. The customer can also make a payment using the POS system. The business owner then receives the customer's request and provides the service. Thus, the owner can manage the business operation by using the POS system. Furthermore, a customer can request a service or product through the POS system, and the owner can manage or track the customer's request through the POS system by managing the customer's database.

A typical POS system is developed utilizing a terminal-oriented system. Typically, customer database, POS management module, and device controller are integrated within the POS system. Thus, a customer can only use the POS system where it is installed. Furthermore, the business owner cannot manage the POS system remotely.

Embodiments of this disclosure relate to a POS system for improving a store's operation efficiency. The POS system can be managed wirelessly. A business owner can manage its services remotely by using a mobile device. The business owner can also remotely manage customers' databases. The business owner can provide a higher quality of service to the customers by managing the customers' database. A customer can request a service and make a payment wirelessly.

In the following detailed description, reference is made to the accompanying drawings, which form a part hereof. In the drawings, similar symbols typically identify similar components unless context dictates otherwise. Thus, in some embodiments, part numbers may be used for similar components in multiple figures, or part numbers may vary from figure to figure. The illustrative embodiments described in the detailed description, drawings, and claims are not meant to be limiting. Some embodiments may be utilized, and other changes may be made without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

Reference in the specification to “one embodiment,” “an embodiment,” or “in some embodiments” means that a particular feature, structure, or characteristic described in connection with the embodiment is included in at least one embodiment of the invention. Moreover, the appearance of these or similar phrases throughout the specification do not necessarily all refer to the same embodiment, nor are separate or alternative embodiments necessarily mutually exclusive. Various features are described herein, which may be exhibited by some embodiments and not by others. Similarly, various requirements are described, which may be requirements for some embodiments but may not be requirements for other embodiments.

In some embodiments, the POS system comprises a network module, a device, and an application programming interface (API) module. In these embodiments, the device is wirelessly connected with the API module. Examples of wireless connection protocols that may be used include Bluetooth protocol, local area network (LAN) protocol, mesh network module protocol, Internet protocol (IP), or mobile Internet protocol (MIP). In a preferred embodiment, the device and the API module are connected using IP or MIP. Thus, a customer or business owner can access the POS system using a personal computer or mobile device.

In some embodiments, the device comprises a database, a POS management module, and a display unit. In these embodiments, the POS management module can access to the database. The database may store one or more of the following data: a service electronic record database configured to store one or more electronic records of service; an item label data database configured to store data for one or more of service labels; a customer data database configured to store data for one or more of customer's identification number; and a customer's electronic record database configured to store the service provided to the customer. The POS management can also update the database. The POS management module can process an input data from the API module. The input data can be a customer or business owner's request in the API module. For example, a customer or business owner can request a service through the API module. The POS management module can receive the request as input data and process the input data. Once the process is completed, the processed data can be displayed on the display unit.

In some embodiments, the API module comprises an application and an external API interface. In these embodiments, a user can request a service through the application. One or more external APIs can be connected to the API module through the external API interface. In one example, a user can make a payment by accessing an external API such as a payment API. In another example, a business owner can check a customer's service status and can send the update to its customer by sending a text message using an external API such as an SMS texting API.

In some embodiments, the network module comprises a backup server, a service server, and a developer terminal. In these embodiments, the POS management module periodically store its data in the backup server. In a case of the POS management module's failure, a technician can assess the POS management module through the service server and recover any lost data using the backup server.

In some embodiments, the application can provide a customization feature. In these embodiments, a user can customize the application based on its provided service or business operation. Furthermore, the application may provide multiple themes, and the user can select any theme.

In some embodiments, the POS management module includes a database management system. The POS management module can manage the database by converting its data format.

In some embodiments, the POS system implements user-friendly functions.

In some embodiments, a developer can directly access the POS management module. In these embodiments, the developer terminal in the network module and the POS management module in the device is wirelessly connected.

In some embodiments, the database and the POS management module can be integrated as a module. In these embodiments, the POS management module functions as an interface because the network module and API module are connected to the device through the POS management module. Examples of wireless connection protocols that may be used include Bluetooth protocol, local area network (LAN) protocol, mesh network module protocol, Internet protocol (IP), or mobile Internet protocol (MIP).

In some embodiments, a developer can update the POS system. In these embodiments, the POS system can be connected to a maintenance web platform. Thus, the POS system can be continuously updated.

In some embodiments, the POS can support an unmanned store operation environment. In these embodiments, a self-device and self-ordering stations are installed in a store. The device can include any suitable self-device for displaying an input, such as a touchscreen device. In such embodiments, the self-device and the self-ordering stations are wirelessly connected to the maintenance web platform.

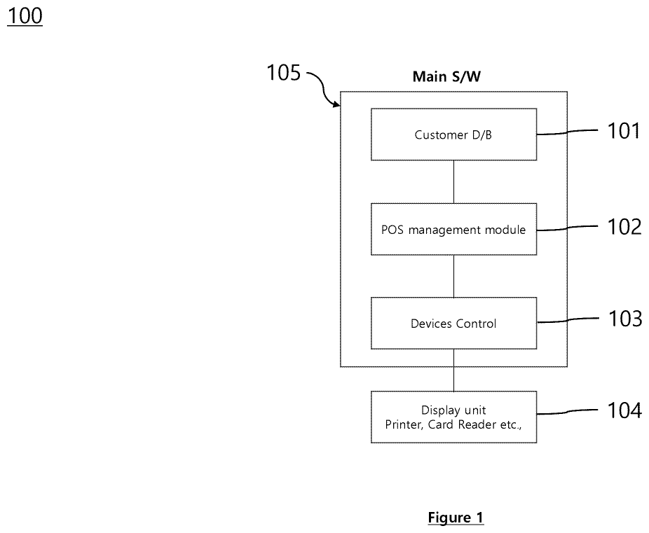

FIG. 1 illustrates a typical POS system 100. As shown in FIG. 1, the POS system 100 comprises a customer database 101, a POS management module 102, a device controller 103, and an input/output module 104 comprising, for example, a display unit, a printer, a card reader, etc. The customer database 101, the POS management module 102, and the device controller 103 can be integrated as a software or hardware module.

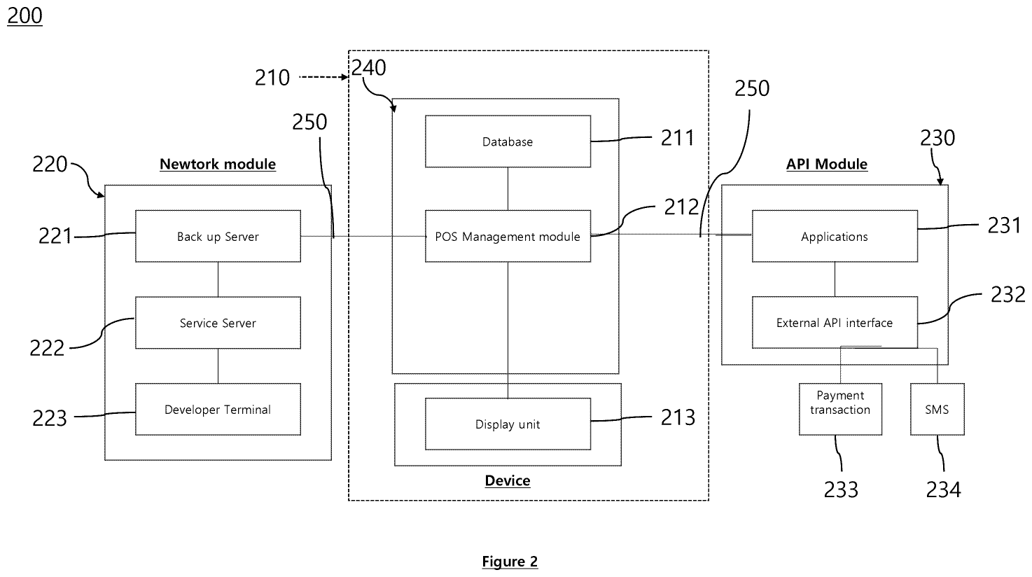

FIG. 2 illustrates an example block diagram of a POS system 200 for improving a store operation efficiency by using a POS device 210 according to some embodiments. The POS system 200 comprises a POS device 210, a network module 220, and an API module 230. The system 200 shown in FIG. 2 is merely an example POS system, and certain elements may be modified or removed, two or more elements combined into a single element, and/or other elements or equipment may be added. As shown in FIG. 2, the device 210 comprises a database 211, a POS management module 212, and a display unit 213. The API module 230 comprises an application 231 and an external API module interface 232. The network module 220 includes a backup server 221, a service server 222, and a developer terminal 223. The term “module” described in this application may include one or more of software, hardware, firmware, or a combination thereof.

As shown in FIG. 2, the device 210 is connected to the API module 230 and the network module 220. The POS management module 212 functions as an interface between the device 210, the API module 230, and the network module 220. The POS management module 212 is connected to the application 231 and the backup server 221. In some embodiments, the connection 250 is a wireless connection. Example of wireless connection protocols that may be used includes Bluetooth protocol, local area network (LAN) protocol, mesh network module protocol, Internet protocol (IP), or mobile Internet protocol (MIP). In some embodiments, the POS management module 212, the application 231, and the backup server 221 are wirelessly connected using the IP or MIP.

In some embodiments, the API module 230 can be installed on a personal device such as a mobile phone, tablet device, or personal computer. Thus, a user can request any service provided by the POS system by using a personal device. The user's request is input data, and the user can request or select any services provided in the POS system 200 by using the application 231. After receiving the input data from a user, the application 231 sends the input data to POS management module 212. Then, the API module 230 changes it's status as inactive. Upon receiving an update from the device 210, the API module 230 is configured to perform a payment transaction or send a message to the user 233. For example, the application 231 receives input data from a user and changes its status to inactive. When the application 231 receives any data from the POS management module 212, the API module 230 is interrupted, and the application 231 processes the received data from the POS management module. Example processes performed by the application 231 can include a payment transaction or sending a message to the user. As shown in FIG. 2, the application 231 is connected to the external API module interface 232. Any external API module such as payment transaction or SMS API module can be connected to the API module 230 through the external API module interface 232. For example, if the received data is a completion of service, the API module 230 may send a notification to the user, and the user can complete the payment transaction. If the received data is related to the POS system 200 operation, the API module 230 sends a notification to the user, and the user can perform the operation.

As shown in FIG. 2, the device 210 comprises a customer database 211, a POS management module 212, and a display unit 213. For example, in some embodiments, as shown in FIG. 2, the customer database 211 and the POS management module 212 can be integrated as a main module 240. In some embodiments, the POS management module 212 receives an input data from the application 231. Upon receiving the input data, the POS scans the database 211. The scanning database 211 comprises one or more: i) a service electronic record database configured to store one or more of electronic records of service, ii) an item label data database configured to store data for one or more of service labels, iii) a customer data database configured to store data for one or more of customer's identification number, or iv) a customer's electronic record database configured to store the service provided to the customer. After or concurrently with the scanning, the POS management module 212 processes the received data. The process may include one or more of the followings: updating the database 211, performing a payment transaction, generating status of the POS system 200, generating status of service; monitoring the POS system 200, or managing user database; and tracking a user's request. The POS management module 212 is configured to send the processed data to the application 231. The POS management module 212 also sends the received input and processed data to the backup server 221.

As shown in FIG. 2, the network module 220 comprises a backup server 221, a service server 222, and a developer terminal 223. The backup server 221 is connected to the POS management module 212. In some embodiments, the POS management module 212 periodically sends data such as customer information, input data, the status of service, or any processed data. Thus, the backup server 221 stores the data. In some embodiments, when the device 210 has an error, the data stored in the device 210 is removed, the device 210 can be recovered by downloading the stored data in the backup server 221.

A POS system operator can perform the system maintenance and update by accessing the service server 222 or developer terminal 223. The service server 222 is connected to the backup server 221 and configured to access the backup server 221. In some embodiments, a POS system operator uploads any updated or recovery source code to the backup server. Then, the backup server 221 sends the source code to the device 210, where the device 210 is rebooted outside of regular business hours. Thus, the POS system operator can perform the system maintenance without interrupting the store operation. Furthermore, a developer can access the POS system 200 through the developer terminal 223. In some embodiments, the developer can use the stored data in the backup server 221 in the system development.

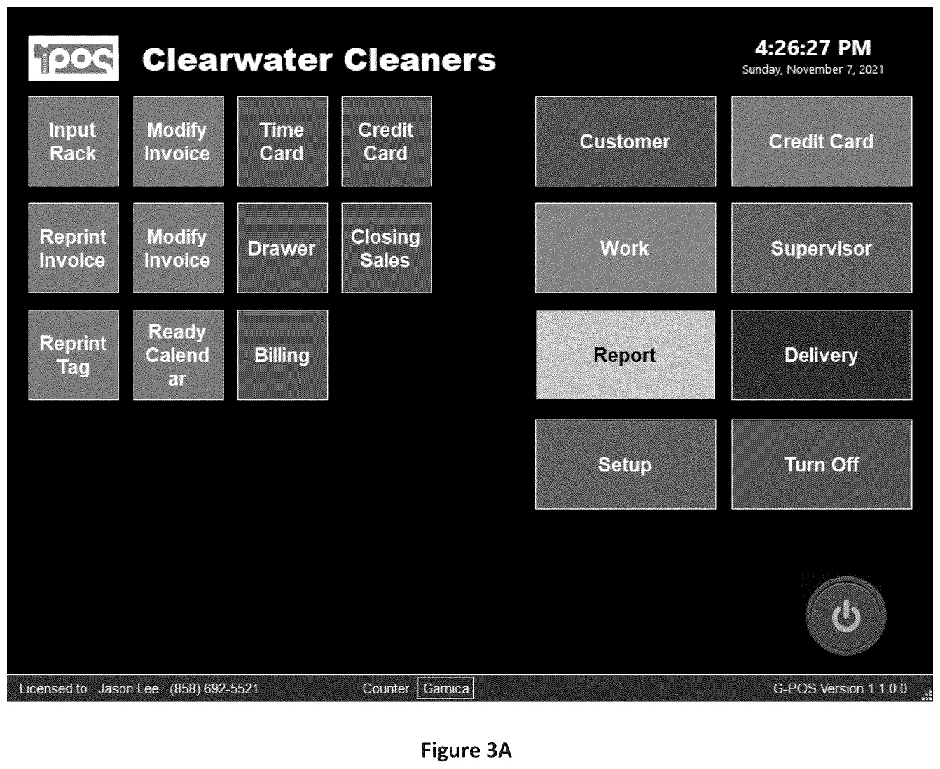

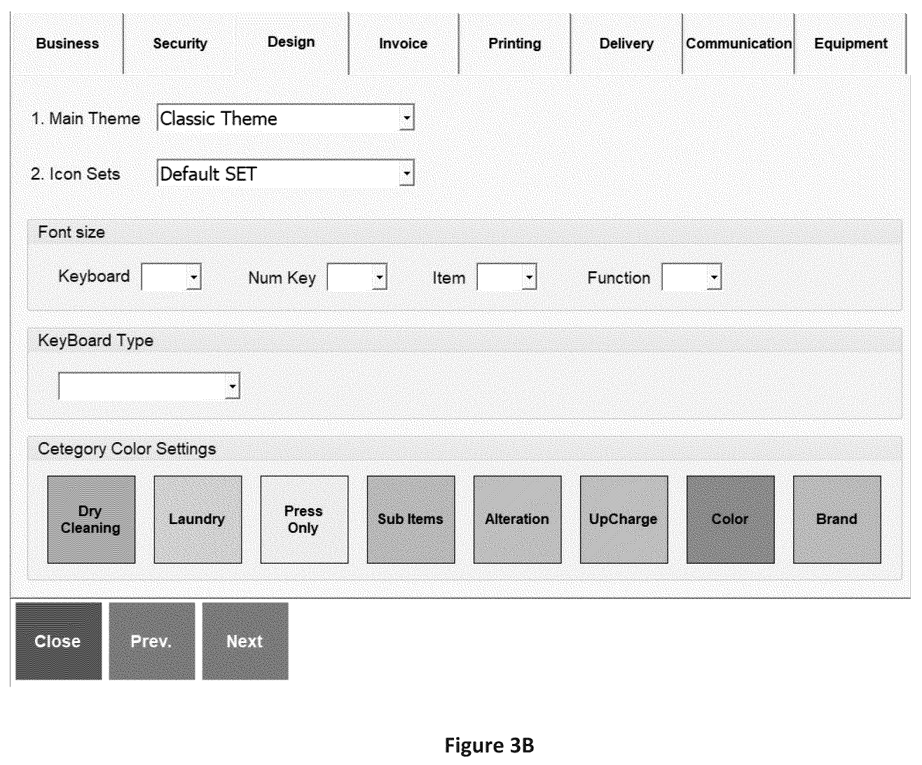

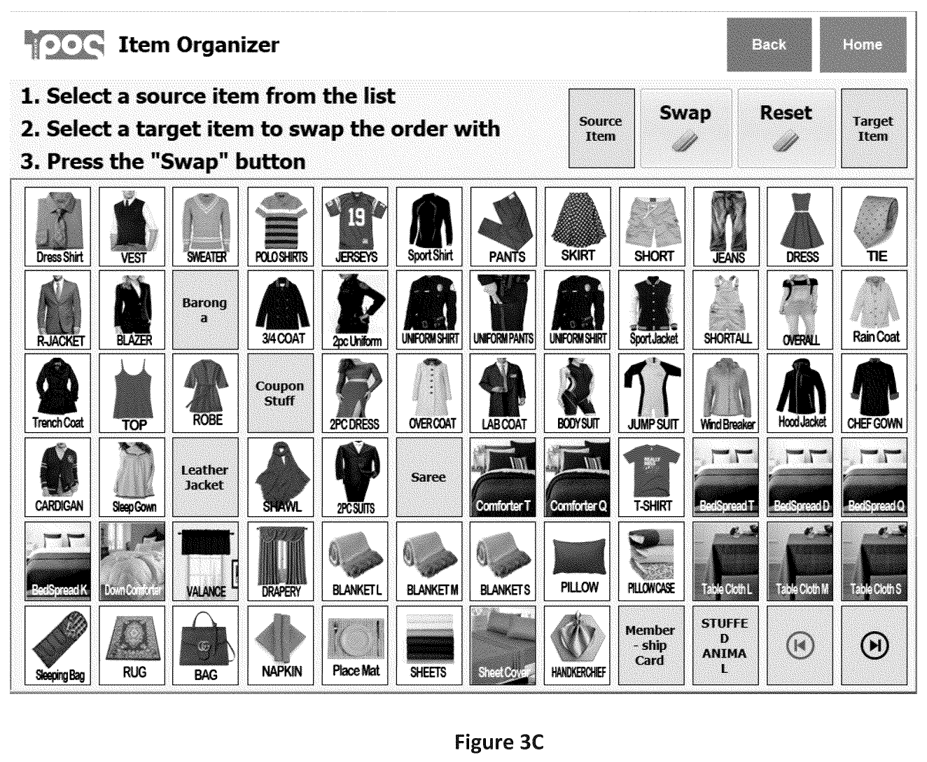

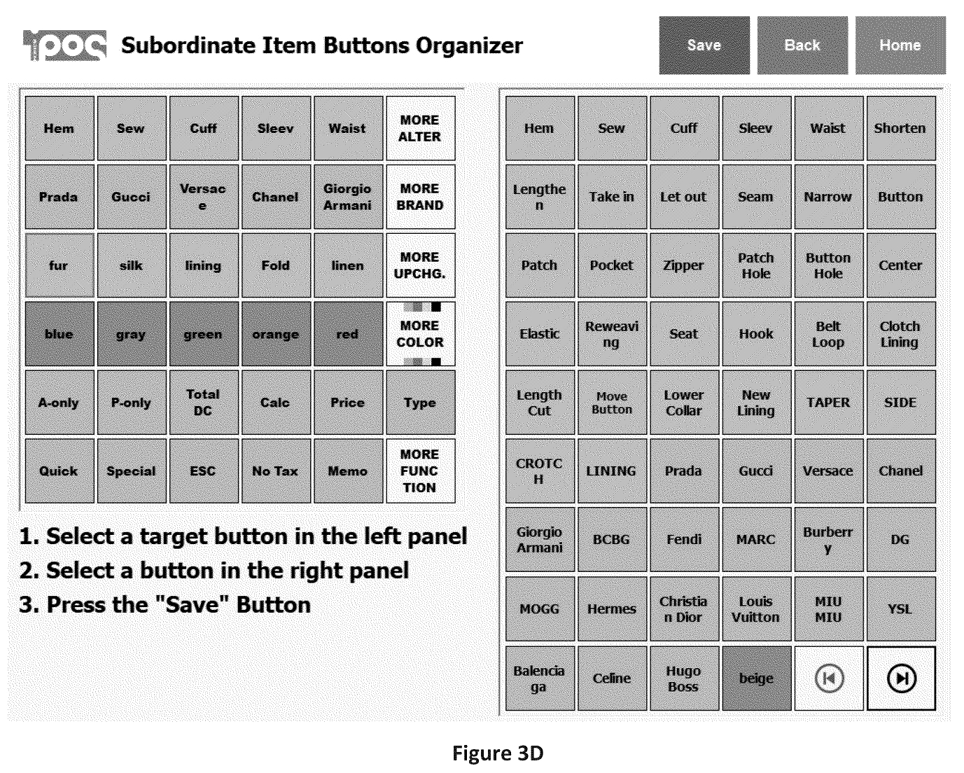

FIGS. 3A-3D show various examples of the application 231 (shown in FIG. 2) according to some embodiments. As shown in FIGS. 3A-3D, the user interface in the application 231 can be customized based on a store's operation and business type. The customization may be performed in the application 231 (shown in FIG. 2), the POS management module 212 (shown in FIG. 2), or through the network module 220 (shown in FIG. 2).

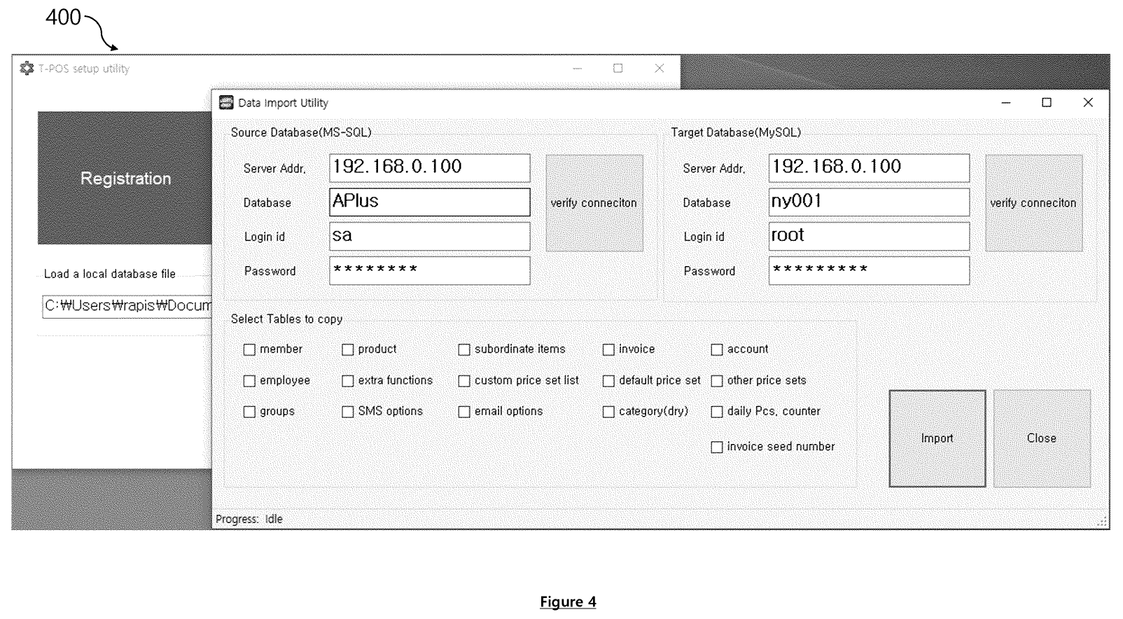

FIG. 4 shows a diagram explaining example management functions of the database 211 (shown in FIG. 2) according to some embodiments. In some embodiments, the database 211 (shown in FIG. 2) has a converting function that converts some existing customer's databases into an advanced my structured Query language (My SQL). The conversion can improve the database performance in scanning and uploading data.

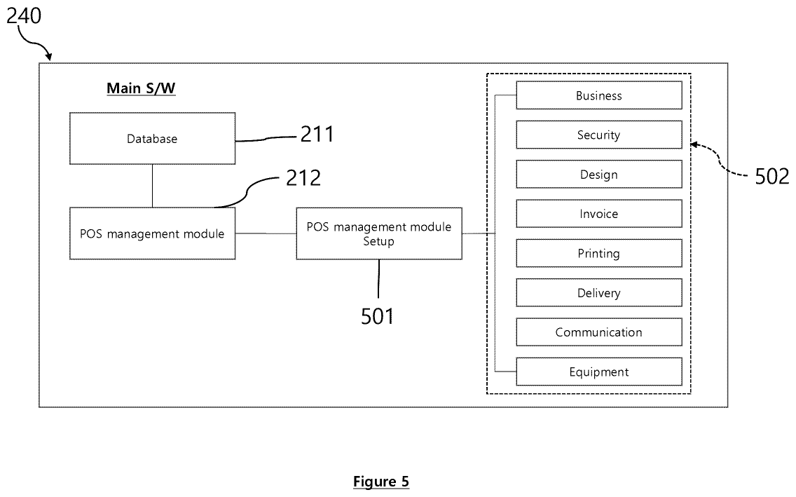

FIG. 5 shows an example block diagram of the main module 240 of the device 210 (shown in FIG. 2) according to some embodiments. As shown in FIG. 5, the main module 240 comprises the database 211, the POS management module 212, and a POS module set-up function 501. The POS module set-up function 501 includes multiple set-up menus 502. The set-up menus 502 are customizable based on a store's operation and business type. The customization may be performed in the application 231 (shown in FIG. 2), the POS management module 212 (shown in FIG. 2), or through the network module 220 (shown in FIG. 2).

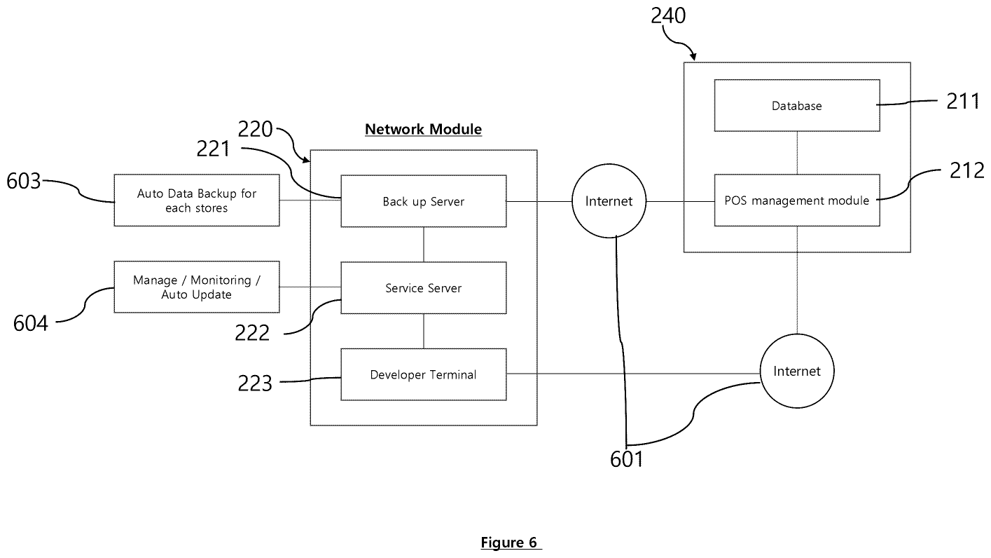

FIG. 6. illustrates an example diagram explaining the POS system's technical support or maintenance. As shown in FIG. 6, an auto data backup 603 and managing server 604 modules are respectively connected to the backup server 221 and the service server 222. In the embodiment, as shown in FIG. 6, the network module 220 is located in a remote place, where the main module 240 is located in a store. The network module 220 and the main module 240 are wirelessly connected via the Internet protocol 601. The database 211 for the main module 240 is automatically stored in the backup server 221. Furthermore, the POS system operator can monitor the backup status of the managing server 604. For example, at a support center, a POS system operator can manage all the main modules 240 in every store, where the POS system is installed. The main module 240 in each store sends its data to the backup server 220 located in the support center, where the POS system manager monitors 604 the backup server. In the case of failure of the main module 240, the POS system manager can remotely diagnose and provide any technical support.

In some embodiments, the POS system can be operated online.

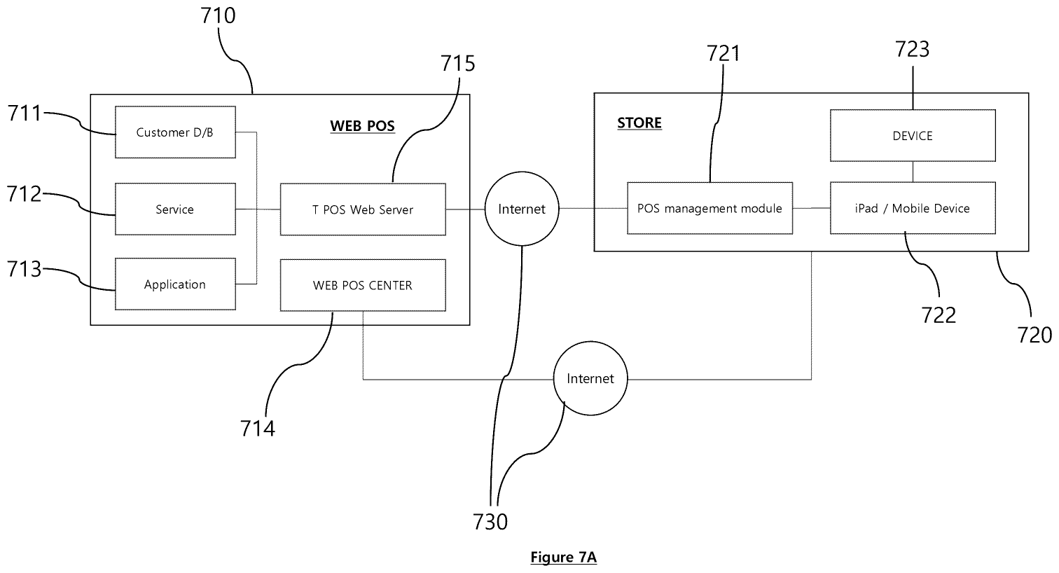

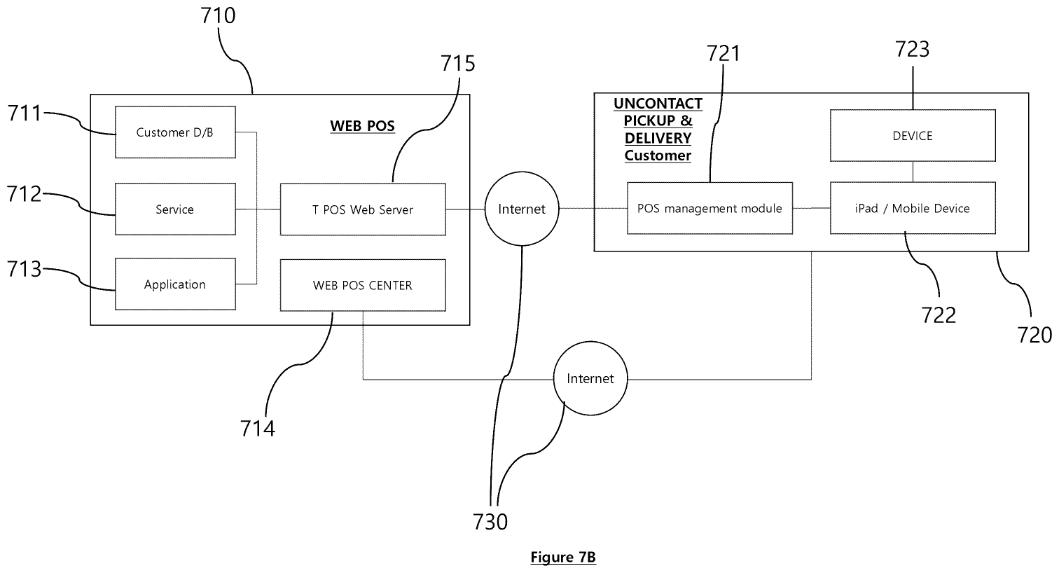

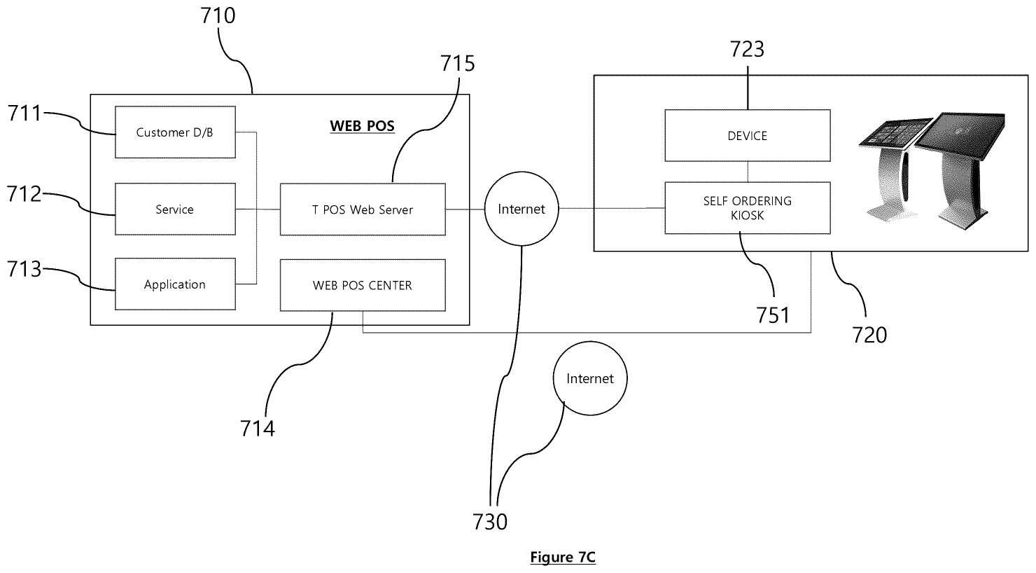

FIGS. 7A-7C illustrate various embodiments of a remote connection between a web POS 710 and a store POS 720.

As shown in 7A, for example, the web POS 710 is a technical support POS and comprises a database 711, a service 712, an application 713, a web server 715, and a web POS center 714. The store POS 720 comprises a device 723. The web POS 710 and the store POS 720 are wirelessly connected using an Internet protocol 730. In the embodiment, the POS web server 715 and the POS monitor 721 are wirelessly connected. Furthermore, the web POS center 715 and the store 720 are wirelessly connected, where the web POS center provides a technical support to the store 720.

For example, as shown in 7B, the web POS 710 comprises a database 711, a service 712, an application 713, a web server 715, and a web POS center 714. The store POS 720 comprises a device 723, a POS management module 721, and a mobile device 722. In the embodiment, the POS web server 715 and the POS management module 721 are wirelessly connected. Furthermore, the web POS center 715 and the store POS 720 are wirelessly connected, for example, using the Internet 730 or other wireless communication protocols, where the web POS center 715 provides a technical support to the store POS 720.

As shown in 7C, in one embodiment, the POS system can be used in unmanned environment in a store operation. FIG. 7C shows, as an example, the web POS 710 that comprises a database 711, a service 712, an application 713, a web server 715, and a web POS center 714. The store POS 720 comprises a device 723 and a self-ordering kiosk 751. In the embodiment, the POS web server 715 and the self-ordering kiosk 751 are wirelessly connected, for example, using the Internet 730 or other wireless communication protocols. Furthermore, the web POS center 715 and the POS store 720 are wirelessly connected, where the web POS center provides technical support to the POS store 720.

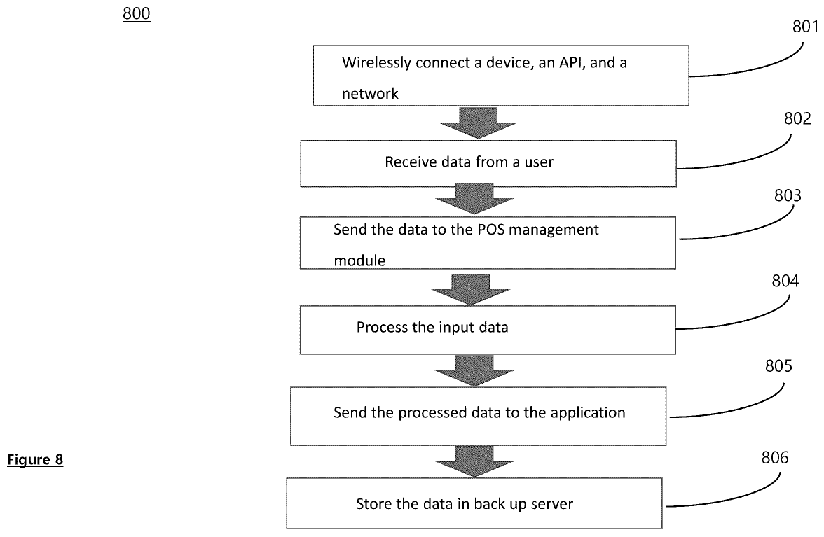

FIG. 8 is a process flow diagram 800 of a method for improving a store operation efficiency by using a POS system according to some embodiments. The process flow diagram 800 may be implemented by a computing device such as the POS management module 212 shown in FIG. 2. FIG. 8 is merely an example process flow diagram for improving a store operation efficiency by using a POS system according to some embodiments, and certain states elements may be removed, other states added, two or more states combined or one state can be separated into multiple states depending on the specification and requirements. In state 801, a device 210, an API module 230, and a network module 220 are wirelessly connected to each other. In state 802, an application 231 receives an input data from a user. In state 803, the application 231 sends the input data to a POS management module 212. In state 804, the POS management module 212 process the input data. In state 805, the POS management module 212 sends the processed data to a backup server 221 and to the application 231. In state 806, the backup server 221 stores the processed data.

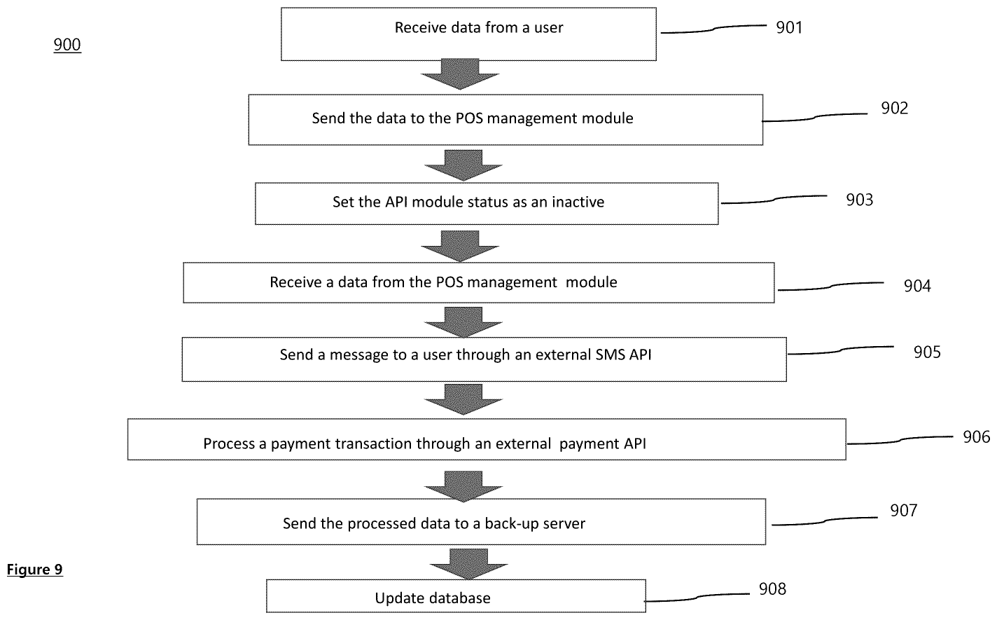

FIG. 9 is another process flow diagram 900 of a method for improving a store operation efficiency by using a POS system according to some embodiments. The process flow diagram 900 may be implemented by a computing device such as the API module 230 shown in FIG. 2. FIG. 9 is merely an example process flow diagram for improving a store operation efficiency by using a POS system according to some embodiments, and certain states elements may be removed, other states added, two or more states combined or one state can be separated into multiple states depending on the specification and requirements. In state 901, the application 231 receives an input data from a user. In state 902, the application 231 sends the input data to the POS management module 212. In state 903, the application 231 sets the API module 230 status as inactive. In state 904, if the POS management module 212 sends any data to the application 231, the API module 230 status is interrupted and changed to an active. In state 905, the application 231 sends a message to a user through an SMS API module. The SMS API module is connected to the application 231 by using an external API module interface 232. In state 906, if the message is the completion of service, the application 231 sends a message to the user to make a payment and process the payment transaction. The payment API module is connected to the application 231 by using an external API module interface 232. In state 907, the POS management module 212 sends the processed data to a backup server. In state 908, the database updates its data.

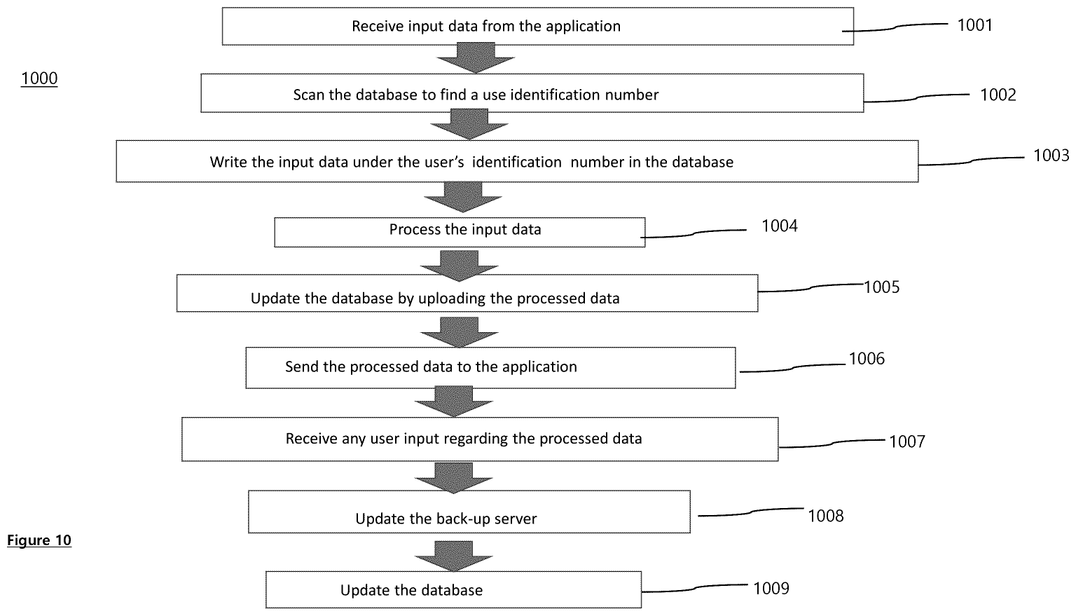

FIG. 10 is another process flow diagram 1000 of a method for improving a store operation efficiency by using a POS system according to some embodiments. The process flow diagram 1000 may be implemented by a computing device such as the POS management module 212 shown in FIG. 2. FIG. 10 is merely an example process flow diagram for improving a store operation efficiency by using a POS system according to some embodiments, and certain states elements may be removed, other states added, two or more states combined or one state can be separated into multiple states depending on the specification and requirements. In state 1001, the POS management module 212 (as shown in FIG. 2) receives an input data from the application 231. In state 1002, the POS management module 212 scans the database 211 to find a user identification number. A unique identification number is assigned to each user and stored in the database. In state 1003, the POS management module 212 writes the input data under the user's identification number. In state 1004, the POS management module 212 process the data at step 1004. The process may include one or more of the following: i) updating the database 211, ii) performing a payment transaction, iii) generating status of the POS system 200, iv) generating status of service, v) monitoring the POS system 200, vi) managing user database, or vii) tracking a user's request. In state 1005, the POS management module 212 updates the database 211 with the processed data. In state 1006, the POS management module 212 sends the processed data to the application 231. In state 1007, the POS management module 212 receives user input from the application 231. The user input can be any request from the user such as payment transaction, request for change service, request for additional service. In state 1008, the POS management module 212 updates its data stored in the backup server 221. In state 1009, the POS management module 212 updates its data stored in the database 211.

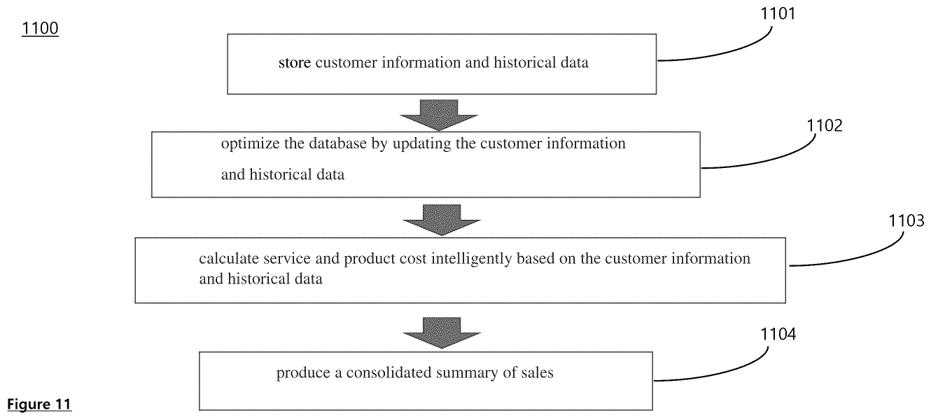

FIG. 11 is another process flow diagram 1100 of a method for improving a store operation efficiency by using a POS system according to some embodiments. The process flow diagram 1100 may be implemented by a computing device such as the POS device 210 shown in FIG. 2. FIG. 11 is merely an example process flow diagram for improving a store operation efficiency by using a POS system according to some embodiments, and certain states elements may be removed, other states added, two or more states combined or one state can be separated into multiple states depending on the specification and requirements. In state 1101, the database 211 of the POS device 210 stores data such as customer information and historical transaction data of the customer.

In state 1102, the POS management module 212 of the POS device 210 optimizes the database by updating the customer information and historical transaction data. For example, by using a Maria DB (a type of MY SQL DB engine) as a database engine, the POS device 210 can create optimized data with faster and more powerful functions than existing products. This can improves the overall speed of the POS management module, through which it generates various types of data. As a result, the POS management module 212 can provide a convenient environment for easily transferring and accessing data to a cloud and mobile environment.

In state 1103, the POS management module 212 of the POS device 210 calculates service and product cost intelligently, for example, based on up-to-date customer information and historical transaction data by accessing the database.

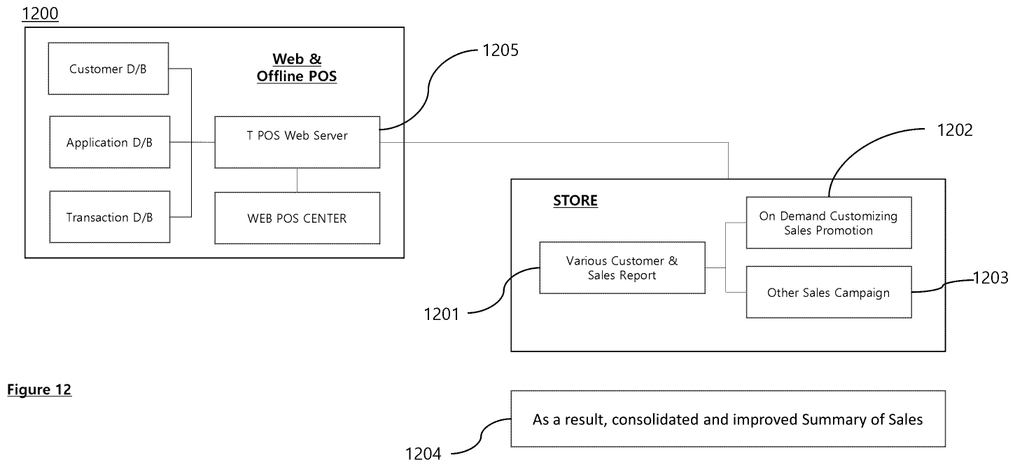

In state 1104, the POS management module 212 of the POS device 210 produces a consolidated summary of sales. The POS device 210 can provide a various report and sales promotion campaign tool to store owners through various types of data analysis. As a result, The POS device 210 can provide more sales opportunities for store owners, resulting in a consolidated and improved summary of sales (to be described in more detail by referring to FIG. 12).

FIG. 12 is one embodiment of a POS system or POS device 1200 to create a consolidated and improved summary of sale 1204. The POS management module 212 can provide various store management tools 1202. One of the tools is a sales promotion campaign (SPC) tool 1203. A store owner can always access the up-to-date customer sales report using the SPC tool 1203. When the store owner requests to generate a customer sale report, the SPC tool 1203 accesses the T POS web server 1205 and receives up-to-date data. Based on the data, the SPC can create the customer sales report 1201. Furthermore, the POS system can perform a sales promotion 1203. The sales promotion can be customizable to each customer based on the customer's data, stored in the database Thus, the POS system can intelligently generate the summary of sales using the most recent data.

In some embodiments, a non-transitory computer readable medium having stored thereon instructions which when executed by at least one computing device performs all or a portion of the methods described.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or as a combination of electronic hardware and executable module. To clearly illustrate this interchangeability, various illustrative components, blocks, modules, and steps have been described above generally in terms of their functionality. Whether such functionality is implemented as specialized hardware, or as specific module instructions executable by one or more hardware devices, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. An image processing system can be or include a microprocessor, but in the alternative, the image processing system can be or include a controller, microcontroller, or state machine, combinations of the same, or the like configured to generate and analyze indicator feedback. An image processing system can include electrical circuitry configured to process computer-executable instructions. Although described herein primarily with respect to digital technology, an image processing system may also include primarily analog components. For example, some or all of the image file analysis and rotation notation features described herein may be implemented in analog circuitry or mixed analog and digital circuitry. A computing environment can include a specialized computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in specifically tailored hardware, in a specialized module executed by an image processing system, or in a combination of the two. A module can reside in random access memory (RAM) memory, flash memory, read only memory (ROM), erasable programmable read-only memory (EPROM), electrically erasable programmable read-only memory (EEPROM), registers, hard disk, a removable disk, a compact disc read-only memory (CD-ROM), or other form of a non-transitory computer-readable storage medium. An exemplary storage medium can be coupled to the image processing system such that the image processing system can read information from and write information to the storage medium. In the alternative, the storage medium can be integral to the image processing system. The image processing system and the storage medium can reside in an application specific integrated circuit (ASIC). The ASIC can reside in an access device or other monitoring device. In the alternative, the image processing system and the storage medium can reside as discrete components in an access device or other item processing device. In some embodiments, the method may be a computer-implemented method performed under the control of a computing device, such as an access device or other item processing device, executing specific computer-executable instructions.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each is present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

As used herein, the terms “determine” or “determining” encompass a wide variety of actions. For example, “determining” may include calculating, computing, processing, deriving, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the term “selectively” or “selective” may encompass a wide variety of actions. For example, a “selective” process may include determining one option from multiple options. A “selective” process may include one or more of: dynamically determined inputs, preconfigured inputs, or user-initiated inputs for making the determination. In some embodiments, an n-input switch may be included to provide selective functionality where n is the number of inputs used to make the selection.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, the term “message” encompasses a wide variety of formats for communicating (e.g., transmitting or receiving) information. A message may include a machine readable aggregation of information such as an XML document, fixed field message, comma separated message, or the like. A message may, in some embodiments, include a signal utilized to transmit one or more representations of the information. While recited in the singular, it will be understood that a message may be composed, transmitted, stored, received, etc. in multiple parts.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A method of improving store operation efficiency by using a point of sale (POS) platform for a dry cleaning store, a tailor shop, or other laundry related businesses, the method comprising:
wirelessly connecting a POS device, at an application programming interface (API) module, and a network module;
receiving, at the API module, data from a user;
sending, at the API module, the data to a POS management module of the POS device;
storing, at a database of the POS device, customer information and historical transaction data;
processing, at the POS management processor, the data, the processing comprising:
optimizing the database by updating the customer information and historical transaction data,
calculating service and product cost intelligently based on the customer information and historical data, and
producing a consolidated summary of sales;
sending the processed data to an application of the API module; and
storing the processed data in a backup server of the network module.

2. The method of claim 1, further comprising at the API module:
setting an API module status as inactive after the data is sent to the POS management module;
receiving data from the POS management module;
changing the API module status as active;
sending a message to the user through an short message service (SMS) API module, wherein the SMS API module is connected to an application of the API module through an external API module interface; and
sending a message to the user to make a payment and process a payment transaction.

3. The method of claim 1, further comprising at the POS device:
receiving an input data from an application of the API module;
scanning the database of the POS device to determine a user identification number;
writing the input data under the user's identification number in the database;
processing the input data;
updating the database by uploading the processed data;
sending the processed data to the application;
receiving any user input regarding the processed data;
updating the backup server of the network module; and
updating the database.

4. The method of claim 3, further comprising:
receiving an input data;
storing the input data under the customer's identification number;
receiving a completion status;
sending a notification to the user; and
processing payment transactions.

5. The method of claim 1, wherein the API module comprises an application configured to receive the data from the user and an external API module interface configured to communicate data with a third party payment server.

6. The method of claim 1, further comprising displaying, at a display of the POS device, the produced consolidated summary of sales.

7. The method of claim 1, wherein the API module is configured to be installed on a personal mobile device.

8. The method of claim 1 wherein the backup server, the POS management module, and the API module are wirelessly connected via a wireless communication protocol.

9. The method of claim 1, wherein the wireless communication protocol comprises one or more of Bluetooth protocol, local area network (LAN) protocol, mesh network module protocol, Internet protocol (IP), or mobile Internet protocol (MIP).

10. The method of claim 1, wherein the database comprises a web-based cloud storage.

11. A point of sale (POS) device for a dry cleaning store, a tailor shop, or other laundry related businesses, the system comprising:
a database configured to store customer information and historical transaction data; and
a processor in data communication with the database and configured to:
optimize the database by updating the customer information and historical transaction data;
calculate service and product cost intelligently based on the customer information and historical data; and
produce a consolidated summary of sales.

12. The POS device of claim 11, further comprising a display configured to display the produced consolidated summary of sales.

13. The POS device of claim 11, wherein the POS device is integrated into a self-ordering kiosk.

14. A non-transitory computer readable medium comprising instructions to perform a method of operating a point of sale (POS) device for a dry cleaning store, a tailor shop, or other laundry related businesses, the method comprising:
storing, at a database, customer information and historical transaction data;
optimizing, at a processor, the database by updating the customer information and historical transaction data;
calculating, at the processor, service and product cost intelligently based on the customer information and historical data; and
producing, at the processor, a consolidated summary of sales.
